(19) United States
(12) Patent Application Publication
(10) Pub. No.: US 2024/0149913 A1
(43) Pub. Date: May 9, 2024

(54) SYSTEMS AND METHODS FOR ASSESSING AND ENHANCING AUTONOMOUS VEHICLE PERFORMANCE

(71) Applicant: Gatik AI, Inc., Mountain View, CA (US)

(72) Inventors: Adam Campbell, Palo Alto, CA (US); Apeksha Kumavat, Palo Alto, CA (US); Gautam Narang, Palo Alto, CA (US); Arjun Narang, Palo Alto, CA (US)

(73) Assignee: Gatik AI, Inc., Mountain View, CA (US)

(21) Appl. No.: 18/505,036

(22) Filed: Nov. 8, 2023

Related U.S. Application Data
(60) Provisional application No. 63/424,024, filed on Nov. 9, 2022.

(51) Int. Cl. B60W 60/00; B60W 30/095

(52) U.S. Cl. CPC B60W 60/0011; B60W 30/095; B60W 60/0015; B60W 2554/4049

(57) ABSTRACT

An example method includes receiving a scenario that includes scenario road portions and scenario hazards. Human driver performance metrics based on driving performance of human drivers on first road portions at least generally similar to the scenario road portions when the human drivers encountered first hazards at least generally similar to the scenario are received. Autonomous vehicle performance metrics based on autonomous vehicles driving on second road portions at least generally similar to the scenario road portions and encountering second hazards at least generally similar to the scenario are received. A scenario autonomous vehicle performance assessment based on the human driver performance metrics and the autonomous vehicle performance metrics are generated and provided.

### CROSS-REFERENCE TO RELATED APPLICATION

This application claims priority to U.S. Provisional Patent Application No. 63/424,024, filed on Nov. 9, 2022, and entitled “METHOD AND SYSTEM FOR ASSESSING AND ENHANCING AUTONOMOUS VEHICLE PERFORMANCE,” which is incorporated in its entirety herein by reference.

### FIELD OF THE INVENTION(S)

Embodiments of the present invention(s) are generally related to assessing and enhancing the performance of autonomous vehicles, and in particular, to assessing the performance of autonomous vehicles with metrics used to assess the performance of human drivers of vehicles.

### BACKGROUND

Autonomous vehicle developers or manufacturers develop and manufacture autonomous vehicles to drive along public or private roads for various purposes, such as making deliveries or conveying passengers. However, regulatory agencies may not permit autonomous vehicles to operate fully autonomously. Alternatively, regulatory agencies may allow autonomous vehicles to only operate in certain areas or impose other constraints. Regulatory agencies may also regulate autonomous vehicles by requiring autonomous vehicle developers or manufacturers to demonstrate that autonomous vehicles may be safely operated on public roads.

Different regulations apply to human drivers as well. Regulatory agencies, such as Departments of Transportation or Departments of Motor Vehicles of various states within the United States, regulate human drivers by, among other things, imposing requirements human drivers have to meet in order to be permitted to drive vehicles. Such regulatory agencies require human drivers to demonstrate competency of a set of skills or abilities in order to obtain driving licenses.

### SUMMARY

In some aspects, the techniques described herein relate to a non-transitory computer-readable medium including executable instructions, the executable instructions being executable by one or more processors to perform a method, the method including: receiving multiple scenarios, each scenario of the multiple scenarios including one or more scenario road portions and one or more scenario hazards; for each scenario of the multiple scenarios: receiving human driver performance metrics, the human driver performance metrics based on driving performance of one or more human drivers on one or more road portions at least generally similar to the one or more scenario road portions when the one or more human drivers encountered one or more hazards at least generally similar to the one or more scenario hazards; receiving simulation results data for one or more simulated autonomous vehicles driving on one or more simulated road portions at least generally similar to the one or more scenario road portions and encountering one or more simulated hazards at least generally similar to the one or more scenario hazards; determining one or more autonomous vehicle performance metrics based on the simulation results data; and generating one or more scenario autonomous vehicle performance assessments based on the human driver performance metrics and the one or more autonomous vehicle performance metrics; generating one or more composite autonomous vehicle performance assessments based on the one or more scenario autonomous vehicle performance assessments generated for each scenario of the multiple scenarios; and providing the one or more composite autonomous vehicle performance assessments.

The techniques described herein may relate to a non-transitory computer-readable medium wherein the multiple scenarios are multiple first scenarios, the one or more scenario road portions are one or more first scenario road portions, the one or more scenario hazards are one or more first scenario hazards, and wherein the method further includes: receiving multiple second scenarios, each second scenario of the multiple second scenarios including one or more second scenario road portions and one or more second scenario hazards; receiving one or more tags, a tag including information usable for selection of a second scenario of the multiple second scenarios; storing the one or more tags in association with one or more second scenarios of the multiple second scenarios; receiving an objective, the objective indicating a purpose for the one or more composite autonomous vehicle performance assessments; and identifying a subset of second scenarios of the multiple second scenarios based on the objective and the one or more tags associated with the one or more second scenarios to obtain the multiple first scenarios.

In some embodiments, the techniques described herein relate to a non-transitory computer-readable medium wherein the objective includes compliance with one or more laws or regulations and the purpose includes demonstration of compliance with the one or more laws or regulations.

Some embodiments of the techniques described herein may relate to a non-transitory computer-readable medium where the human driver performance metrics include human perception and reaction times and the one or more autonomous vehicle performance metrics include one or more autonomous vehicle perception and reaction times.

The non-transitory computer-readable medium may further include instructions regarding each scenario of the multiple scenarios including steps for determining human collision rates or collision risks based on the human driver performance metrics; and determining one or more autonomous vehicle collision rates or collision risks based on the one or more autonomous vehicle performance metrics.

The non-transitory computer-readable medium may further include instructions regarding each scenario of the multiple scenarios including steps for determining an exposure metric for each scenario based on a likelihood of experiencing each scenario, and wherein generating the one or more scenario autonomous vehicle performance assessments based on the one or more autonomous vehicle performance metrics and the human driver performance metrics includes: determining a difference between a human collision rate or collision risk and an autonomous vehicle collision rate or collision risk; and determining a product of the exposure metric and the difference to obtain the one or more scenario autonomous vehicle performance assessments.

In some aspects, the techniques described herein relate to a non-transitory computer-readable medium wherein generating the one or more composite autonomous vehicle performance assessments based on the one or more scenario autonomous vehicle performance assessments generated for each scenario of the multiple scenarios includes determining a sum of the one or more scenario autonomous vehicle performance assessments generated for each scenario of the multiple scenarios to obtain the one or more composite autonomous vehicle performance assessments.

In various embodiments, one or more road portions are one or more first road portions, the one or more hazards are one or more first hazards, and wherein the method further includes: receiving autonomous vehicle driving data for one or more autonomous vehicles driving on one or more second road portions and encountering one or more second hazards; identifying a particular scenario of the multiple scenarios based on the one or more second road portions and the one or more second hazards; based on the autonomous vehicle driving data, updating the one or more autonomous vehicle performance metrics for the particular scenario to obtain one or more updated autonomous vehicle performance metrics; updating the one or more scenario autonomous vehicle performance assessments based on the one or more updated autonomous vehicle performance metrics to obtain one or more updated scenario autonomous vehicle performance assessments; updating the one or more composite autonomous vehicle performance assessments based on the one or more updated scenario autonomous vehicle performance assessments to obtain one or more updated composite autonomous vehicle performance assessments; and providing the one or more updated composite autonomous vehicle performance assessments.

In some aspects, the techniques described herein relate to a method including: receiving a scenario, the scenario including one or more scenario road portions; receiving one or more human driver performance metrics, the one or more human driver performance metrics based on driving performance of one or more human drivers on one or more first road portions at least generally similar to the one or more scenario road portions; receiving one or more autonomous vehicle performance metrics, the one or more autonomous vehicle performance metrics based on one or more autonomous vehicles driving on one or more second road portions at least generally similar to the one or more scenario road portions; generating one or more scenario autonomous vehicle performance assessments based on the one or more human driver performance metrics and the one or more autonomous vehicle performance metrics; and providing the one or more scenario autonomous vehicle performance assessments.

In some embodiments, the one or more autonomous vehicle performance metrics are based on a simulated autonomous vehicle driving on one or more simulated road portions at least generally similar to the one or more scenario road portions.

In some aspects, the techniques described herein relate to a method wherein the one or more autonomous vehicle performance metrics are based on an autonomous vehicle driving on one or more road portions at least generally similar to the one or more scenario road portions.

The techniques described herein may relate to a method further including: receiving results data for the one or more autonomous vehicles driving on the one or more second road portions at least generally similar to the one or more scenario road portions; and determining the one or more autonomous vehicle performance metrics based on the results data.

In various embodiments, the scenario may be a first scenario, the one or more scenario road portions are one or more first scenario road portions, the one or more human driver performance metrics are one or more first human driver performance metrics, the one or more human drivers are one or more first human drivers, the one or more autonomous vehicle performance metrics are one or more first autonomous vehicle performance metrics, the one or more autonomous vehicles are one or more first autonomous vehicles, the one or more scenario autonomous vehicle performance assessments are one or more first scenario autonomous vehicle performance assessments, and wherein the method further includes: receiving a second scenario, the second scenario including one or more second scenario road portions; receiving one or more second human driver performance metrics, the one or more second human driver performance metrics based on driving performance of one or more second human drivers on one or more third road portions at least generally similar to the one or more second scenario road portions; receiving one or more second autonomous vehicle performance metrics, the one or more second autonomous vehicle performance metrics based on one or more second autonomous vehicles driving on one or more fourth road portions at least generally similar to the one or more second scenario road portions; generating one or more second scenario autonomous vehicle performance assessments based on the one or more second human driver performance metrics and the one or more second autonomous vehicle performance metrics; generating one or more composite autonomous vehicle performance assessments based on the one or more first scenario autonomous vehicle performance assessments and the one or more second scenario autonomous vehicle performance assessments; and providing the one or more composite autonomous vehicle performance assessments.

In some aspects, the techniques described herein relate to a method further including: receiving an objective for providing the one or more composite autonomous vehicle performance assessments; and selecting the first scenario and the second scenario based on the objective. The objective may include compliance with one or more laws or regulations.

In some embodiments, the techniques described herein relate to a method wherein the one or more human driver performance metrics include human perception and reaction times and the one or more autonomous vehicle performance metrics include one or more autonomous vehicle perception and reaction times.

The method may further include: determining one or more human collision rates or collision risks based on the one or more human driver performance metrics; and determining one or more autonomous vehicle collision rates or collision risks based on the one or more autonomous vehicle performance metrics.

In some aspects, the techniques described herein relate to a method, further including determining an exposure metric for the scenario based on a likelihood of experiencing the scenario, and wherein generating the one or more scenario autonomous vehicle performance assessments based on the one or more human driver performance metrics and the one or more autonomous vehicle performance metrics includes: determining a difference between the one or more human collision rates or collision risks and the one or more autonomous vehicle collision rates or collision risks; and determining a product of the exposure metric and the difference to obtain the one or more scenario autonomous vehicle performance assessments.

An example system may include at least one processor and memory containing executable instructions, the executable instructions being executable by the at least one processor to: receive multiple scenarios, a scenario including one or more scenario road portions; receive at least one human driver performance metric for each of the multiple scenarios, the at least one human driver performance metric based on driving performance of one or more human drivers on one or more first road portions; receive at least one autonomous vehicle performance metric for each of the multiple scenarios, the at least one autonomous vehicle performance metric based on one or more autonomous vehicles driving on one or more second road portions at least generally similar to the one or more scenario road portions; generate at least one composite autonomous vehicle performance assessment for the multiple scenarios based on the at least one human driver performance metric for each of the multiple scenarios and the at least one autonomous vehicle performance metric for each of the multiple scenarios; and provide the at least one composite autonomous vehicle performance assessment for the multiple scenarios.

The system may include executable instructions that are further executable by the at least one processor to: receive an objective for providing the at least one composite autonomous vehicle performance assessment for the multiple scenarios; and select the multiple scenarios from a scenario datastore based on the objective. The objective may include compliance with one or more laws or regulations.

In some embodiments, the at least one human driver performance metric includes human perception and reaction times and the at least one autonomous vehicle performance metric includes at least one autonomous vehicle perception and reaction time.

In some embodiments, the techniques described herein relate to a system, wherein the scenario further includes one or more scenario hazards, the at least one human driver performance metric is further based on the driving performance of the one or more human drivers on the one or more first road portions when the one or more human drivers encountered one or more first hazards at least generally similar to the one or more scenario hazards, the at least one autonomous vehicle performance metric is further based on the one or more autonomous vehicles driving on the one or more second road portions and encountering one or more second hazards at least generally similar to the one or more scenario hazards, and wherein the executable instructions are further executable by the at least one processor to: determine at least one human collision rate or collision risk based on the at least one human driver performance metric; and determine at least one autonomous vehicle collision rate or collision risk based on the at least one autonomous vehicle performance metric.

In some aspects, the techniques described herein relate to a system, the executable instructions being further executable by the at least one processor to: determine an exposure metric for each of the multiple scenarios based on a likelihood of experiencing each scenario; determine a difference between the at least one human collision rate or collision risk and the at least one autonomous vehicle collision rate or collision risk for each of the multiple scenarios; and determine a product of the exposure metric and the difference to obtain at least one scenario autonomous vehicle performance assessment for each of the multiple scenarios.

In some embodiments, the executable instructions to generate the at least one composite autonomous vehicle performance assessment for the multiple scenarios based on the at least one human driver performance metric for each of the multiple scenarios and the at least one autonomous vehicle performance metric for each of the multiple scenarios include executable instructions to determine a sum of the at least one scenario autonomous vehicle performance assessment for each of the multiple scenarios to obtain the at least one composite autonomous vehicle performance assessment for the multiple scenarios.

### BRIEF DESCRIPTION OF THE DRAWINGS

FIG. 1 is a block diagram depicting an example environment in which an autonomous vehicle performance assessment system may operate in some embodiments.

FIG. 2 is a block diagram depicting components of an autonomous vehicle performance assessment system in some embodiments.

FIG. 3A is a flow diagram depicting a method for identifying scenarios for use in assessing the performance of autonomous vehicles in some embodiments.

FIG. 3B is a flow diagram depicting a method for assessing the performance of autonomous vehicles in some embodiments.

FIG. 4A is a block diagram depicting a set of multiple scenarios for human drivers and for autonomous vehicles in some embodiments.

FIG. 4B is a block diagram depicting performance metrics for human drivers and for autonomous vehicles in some embodiments.

FIG. 5A is a block diagram depicting a methodology for identifying scenarios for assessing the performance of autonomous vehicles in some embodiments.

FIG. 5B is a block diagram depicting a methodology for generating autonomous vehicle performance assessments in some embodiments.

FIG. 6 depicts a simulation environment in which a simulated autonomous vehicle is driving on one or more simulated road portions and encountering one or more simulated hazards of a simulated scenario in some embodiments.

FIG. 7 is a flow diagram depicting a method for autonomous vehicle development, verification, validation, and deployment in some embodiments.

FIG. 8 is a flow diagram depicting a method for updating performance assessments of autonomous vehicles in some embodiments.

FIG. 9 depicts a block diagram of an example digital device in some embodiments.

Throughout the drawings, like reference numerals will be understood to refer to like parts, components, and structures.

### DETAILED DESCRIPTION

It may be believed that autonomous vehicles must travel distances which are proportional to the amount driven by humans in order to assess, compare, and subsequently validate the performance of the autonomous vehicles against a human benchmark of collision risk. This process may be a prohibitive requirement for autonomous vehicle deployment, as it may require upwards of billions of miles of driving by autonomous vehicle fleets to get a statistically valid number of collision or near-collision exposures as that available in human driving data (for example, to get a statistically significant assessment of autonomous vehicle performance/safety and/or benefit over human driving). Furthermore, a conventional metric in assessing autonomous vehicle performance and demonstrating autonomous vehicle improvement is the number of disengagements and/or the time between disengagements that occur while operating the autonomous vehicle (for example, as initiated by a human safety driver located onboard the autonomous vehicle). This metric type, however, may not directly correlate to real-world collision risk, as disengagements may occur for numerous reasons and in various situations, related or not to collision risk.

In one example, given the vast number of miles driven by humans, it has been suggested that autonomous vehicles would be required to drive upwards of 11 billion miles before any adequate statistical comparison can be made to humans regarding collision frequency and fatal collision rates. It would take a fleet size of autonomous vehicles far beyond that available by current or projected deployment rates decades to accumulate such mileage. This hurdle may limit the acceptance of autonomous vehicles and ultimately their potential to deliver societal benefits.

An autonomous vehicle performance assessment system as described herein may overcome this and other problems. In some embodiments, the autonomous vehicle performance assessment system aggregates human driving performance data for numerous scenarios (e.g., scenarios that humans have driven in). The autonomous vehicle performance assessment system may determine performance metrics for human drivers for the scenarios and allow for the selection or identification of a subset of scenarios for assessing the performance of autonomous vehicles. The system may further allow for the subset of the scenarios to be selected or identified based on an objective or goal (e.g., related to meeting regulatory requirements, meeting customer requirements, demonstrating safety and efficacy, and/or other purposes).

The autonomous vehicle performance assessment system allows for the scenarios to be recreated, reconstituted, or to be simulated. In some examples, a scenario may be recreated in real-world conditions or reconstituted in a controlled environment, such as a closed-course or a private testing facility. An autonomous vehicle may then experience the scenario in the real-world conditions or in the controlled environment. The autonomous vehicle performance assessment may obtain performance data for the autonomous vehicle in the scenario and utilize the performance data to generate one or more performance metrics for the autonomous vehicle. Additionally or alternatively, a scenario may also be simulated, and a simulated version of an autonomous vehicle may experience the simulated scenario. The autonomous vehicle performance assessment may obtain simulated performance data for the simulated autonomous vehicle in the simulated scenario and utilize the simulated performance data to generate one or more performance metrics for the autonomous vehicle.

The autonomous vehicle performance assessment system may utilize the performance metrics for human drivers for scenarios and the performance metrics for autonomous vehicles in the recreated, reconstituted, or simulated scenarios to generate a performance assessment for the autonomous vehicle. The autonomous vehicle performance assessment system may generate a performance assessment such as a score (for example, a percentile, a probability, etc.) for the autonomous vehicle in the scenario. For example, the autonomous vehicle performance assessment system may determine that the autonomous vehicle scores in the 95^{th} percentile (that is, better than 95% of human drivers) in a particular scenario and similar or other scores in other scenarios. Additionally or alternatively, the autonomous vehicle performance assessment system may determine a collision rate or collision risk for the autonomous vehicle in the scenario. The collision rate or collision risk may be expressed as an absolute or as relative to the collision rate or collision risk of human drivers in the scenario.

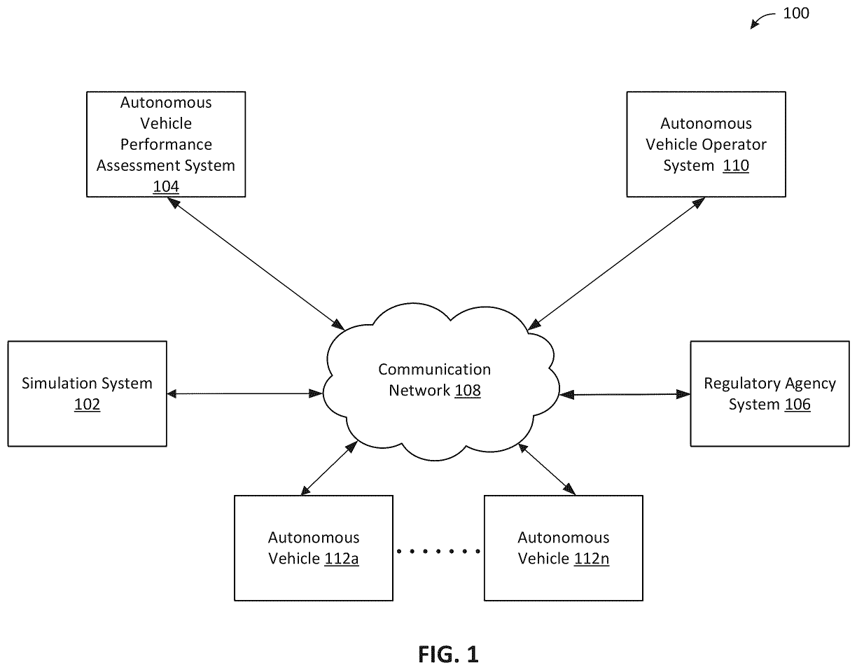

FIG. 1 is a block diagram depicting an example environment 100 in which an autonomous vehicle performance assessment system may operate in some embodiments. The environment 100 includes an autonomous vehicle performance assessment system 104, a simulation system 102, a regulatory agency system 106, an autonomous vehicle operator system 110, multiple autonomous vehicles, shown as an autonomous vehicle 112a through an autonomous vehicle 112n, and a communication network 108.

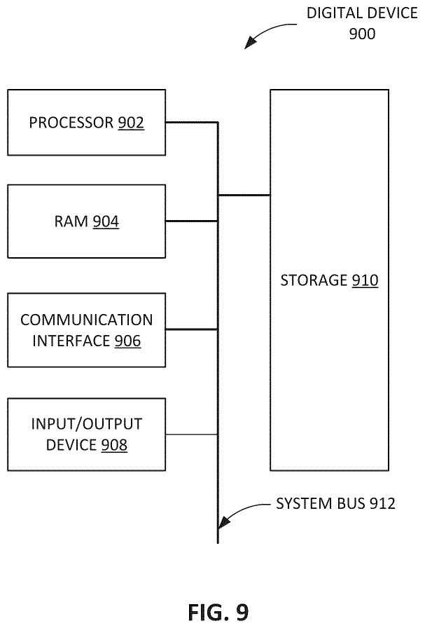

The autonomous vehicle performance assessment system 104 may be or include any number of digital devices. Digital devices are discussed, for example, with reference to FIG. 9. The autonomous vehicle performance assessment system 104 may be operated by an entity that develops, manufactures, assembles, sells, leases, and/or otherwise provides autonomous vehicles. As described in more detail herein, the autonomous vehicle performance assessment system 104 may receive scenarios, receive autonomous vehicle performance data and human driver performance data for the scenarios, and utilize the data to generate performance assessments for autonomous vehicles. The autonomous vehicle performance assessment system 104 may then provide such assessments, such as to the regulatory agency system 106 and/or the autonomous vehicle operator system 110. Human driver performance data may additionally or alternatively include human driver metrics that are extracted and/or generated from statistical analysis, human factors analysis of driver behavior, observations of driver behavior, forensic collision reconstruction, actuarial analysis, subject matter expert opinion, and/or other means of inquiry.

The simulation system 102 may be or include any number of digital devices. The simulation system 102 may receive scenario data and autonomous vehicle data for simulation. The simulation system 102 may simulate autonomous vehicle performance using the scenario data and the autonomous vehicle data and provide the simulation results to the autonomous vehicle performance assessment system 104.

The regulatory agency system 106 may be or include any number of digital devices. The regulatory agency system 106 may provide legal, regulatory descriptions, and/or requirements to the autonomous vehicle performance assessment system 104. The regulatory agency system 106 may receive autonomous vehicle performance assessments from the autonomous vehicle performance assessment system 104.

It will be appreciated that the regulatory agency system 106 is optional. In some embodiments, either in addition or instead of the regulatory agency system 106, the environment 100 may comprise a stake holder system (or equivalent) that may include custerom systems, engineering systems, law enforcement systems, emergency systems, and/or the like. These systems may provide legal, regulatory descriptions, engineering requirements, safety information, and/or customer requirements.

The autonomous vehicle operator system 110 may be or include any number of digital devices. The autonomous vehicle operator system 110 may be operated by an entity that purchases, leases, and/or utilizes autonomous vehicles provided by the entity that operates the autonomous vehicle performance assessment system 104. The autonomous vehicle operator system 110 may provide route descriptions and/or requirements to the autonomous vehicle performance assessment system 104. The regulatory agency system 106 may receive autonomous vehicle performance assessments from the autonomous vehicle performance assessment system 104.

The autonomous vehicle 112a through the autonomous vehicle 112n may include any number of digital devices. The autonomous vehicle 112a through the autonomous vehicle 112n may further include any number of sensors, computing devices, models, and components that facilitate autonomous or semi-autonomous operation.

In some embodiments, the communication network 108 represents one or more computer networks (for example, LANs, WANs, and/or the like). The communication network 108 may provide communication between or among any of the simulation system 102, the regulatory agency system 106, the autonomous vehicle operator system 110, and the autonomous vehicle performance assessment system 104. In some implementations, the communication network 108 comprises computer devices, routers, cables, and/or other network topologies. In some embodiments, the communication network 108 may be wired and/or wireless. In various embodiments, the communication network 108 may comprise the Internet, one or more networks that may be public, private, IP-based, non-IP based, and so forth.

Although FIG. 1 depicts only one autonomous vehicle performance assessment system, simulation system, regulatory agency system, autonomous vehicle operator system, and communication network in the environment 100, the environment 100 may include any number of the autonomous vehicle performance assessment system(s) 104, the simulation system(s) 102, the regulatory agency system(s) 106, the autonomous vehicle operator system(s) 110, and/or the communication network(s) 108. Moreover, the environment 100 may include systems associated with other entities, such as other governmental entities (for example, police and/or law enforcement entities), other non-governmental entities (for example, customers of the entity that operates the autonomous vehicle performance assessment system 104), and sub-units of the entity that operates the autonomous vehicle performance assessment system 104 (for example, engineering, product, and/or legal organizations). Such systems associated with other entities may also provide legal, regulatory descriptions, and/or requirements to the autonomous vehicle performance assessment system 104, and/or receive autonomous vehicle performance assessments from the autonomous vehicle performance assessment system 104. Furthermore, the environment 100 may include any number of components other than those illustrated in FIG. 1 that may facilitate assessing and enhancing autonomous vehicle performance.

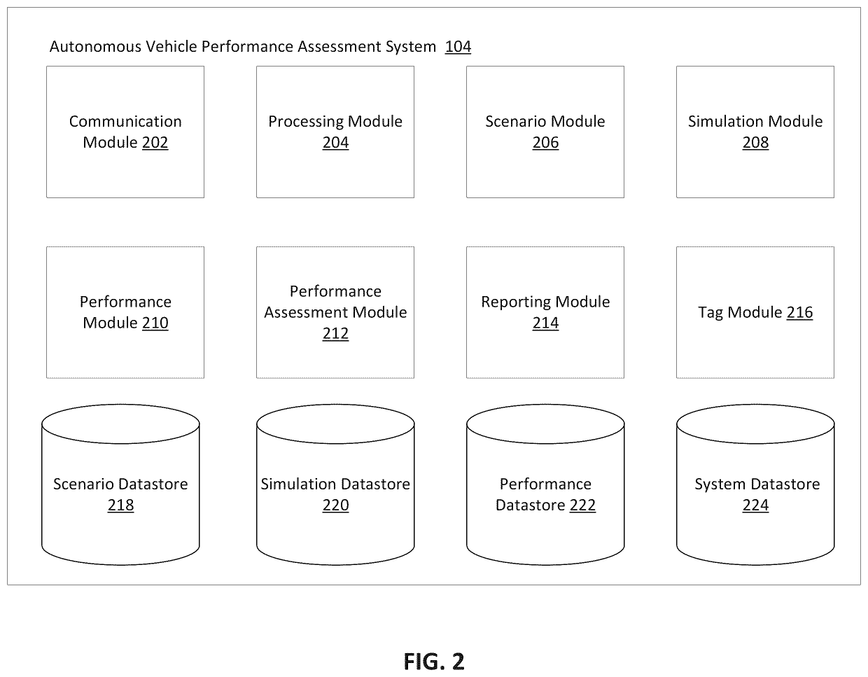

FIG. 2 is a block diagram depicting components of the autonomous vehicle performance assessment system 104 in some embodiments. The autonomous vehicle performance assessment system 104 includes a communication module 202, a processing module 204, a scenario module 206, a simulation module 208, a performance module 210, a performance assessment module 212, a reporting module 214, a tag module 216, a scenario datastore 218, a simulation datastore 220, a performance datastore 222, and a system datastore 224.

The communication module 202 may send and/or receive requests and/or data between the autonomous vehicle performance assessment system 104 and the simulation system 102, the regulatory agency system 106, and the autonomous vehicle 112a through the autonomous vehicle 112n. The communication module 202 may receive requests and/or data from the simulation system 102, the regulatory agency system 106, the autonomous vehicle 112a through the autonomous vehicle 112n, and/or other systems. The communication module 202 may also send requests and/or data to the simulation system 102, the regulatory agency system 106, the autonomous vehicle operator system 110, the autonomous vehicle 112a through the autonomous vehicle 112n, and/or other systems.

The processing module 204 may process data, such as scenario data, human driver results data, and/or autonomous vehicle results data. In various embodiments, the processing module 204 may perform feature generation, normalization of data, metadata generation, and/or the like.

The scenario module 206 may extract scenario features from data associated with human driving performance to obtain extracted scenario features, transform the extracted scenario features to obtain transformed scenario features, and load the transformed scenario features into the scenario datastore 218.

The simulation module 208 may perform simulations of autonomous vehicles driving in simulated scenarios and/or process simulation results data provided by the simulation system 102.

The performance module 210 may receive human driver performance metrics and determine autonomous vehicle performance metrics based on the autonomous vehicle performance data.

The performance assessment module 212 may generate scenario autonomous vehicle performance assessments based on human driver performance metrics and autonomous vehicle performance metrics. The performance assessment module 212 may also generate composite autonomous vehicle performance assessments based on the scenario autonomous vehicle performance assessments.

The reporting module 214 may provide scenario autonomous vehicle performance assessments and composite autonomous vehicle performance assessments to, for example, the autonomous vehicle operator system 110 and/or the regulatory agency system 106. The reporting module 214 may provide reports, alerts, and/or dashboards that include autonomous vehicle performance assessments or other information regarding autonomous vehicles.

The tag module 216 may receive tags to associate with scenarios and store the tags in association with the scenarios in the scenario datastore 218.

The scenario datastore 218 may include scenario data, scenario features, tags, and/or other data relating to scenarios. The scenario datastore 218 may include any number of data storage structures such as tables, databases, lists, and/or the like.

The simulation datastore 220 may include data for running simulations of autonomous vehicles in scenarios, autonomous vehicle specification and/or attribute data, and/or results data from simulation of autonomous vehicles in scenarios. The simulation datastore 220 may include any number of data storage structures such as tables, databases, lists, and/or the like.

The performance datastore 222 may include data associated with human driving performance, data associated with autonomous vehicle driving performance, and/or any other data relating to driving performance. The performance datastore 222 may include any number of data storage structures such as tables, databases, lists, and/or the like.

The system datastore 224 may include data stored, accessed, and/or modified by any of the modules of the autonomous vehicle performance assessment system 104. The system datastore 224 may include any number of data storage structures such as tables, databases, lists, and/or the like.

A module of the autonomous vehicle performance assessment system 104 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, and/or any combination. Software may be executed by one or more processors. Although a limited number of modules are depicted in FIG. 2, there may be any number of modules. Further, individual modules may perform any number of functions, including functions of multiple modules as shown herein. Further, modules depicted as being included in the autonomous vehicle performance assessment system 104 may be additionally or alternatively included in any of the simulation system 102, the regulatory agency system 106, the autonomous vehicle operator system 110, and the autonomous vehicle 112a through the autonomous vehicle 112n, or in systems not illustrated in FIG. 1.

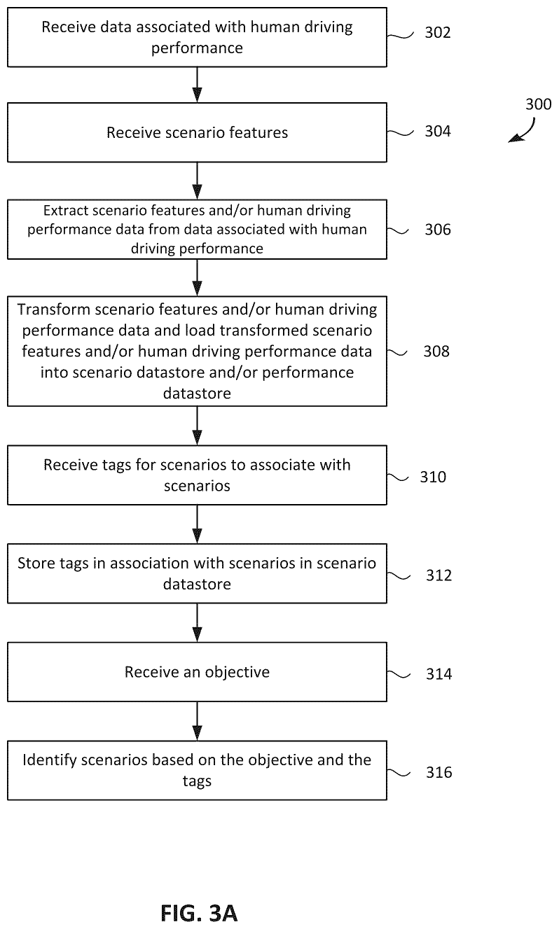

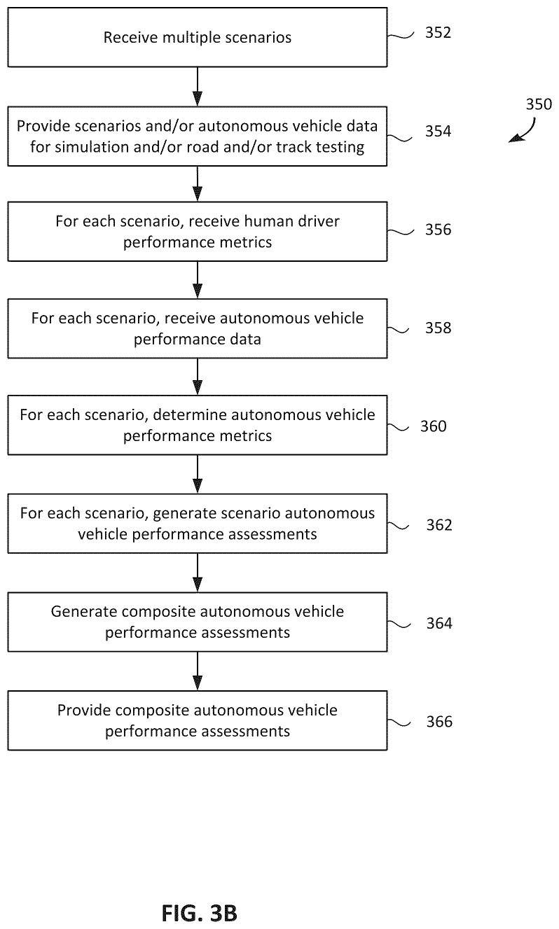

FIG. 3A is a flow diagram depicting a method 300 for identifying scenarios for use in assessing the performance of autonomous vehicles in some embodiments. Various modules of the autonomous vehicle performance assessment system 104 may perform the method 300. In some embodiments, some or all of the method 300 may be performed by the simulation system 102, the regulatory agency system 106, the autonomous vehicle operator system 110, and/or other systems.

The method 300 begins at step 302, where the autonomous vehicle performance assessment system 104 (for example, the communication module 202) receives data associated with human driving performance. For example, the autonomous vehicle performance assessment system 104 may receive data associated with human driving performance from datasets that are in the public domain or that are licensed to the entity operating the autonomous vehicle performance assessment system 104. As another example, the autonomous vehicle performance assessment system 104 may receive data associated with human driving performance from datasets associated with research studies, papers and/or publications. In some embodiments, the autonomous vehicle performance assessment system 104 may receive data associated with human driving performance from research studies, naturalistic driver performance databases, insurance claim datasets, police agency investigations, forensic engineering datasets, collision reports, collision databases, police reports and/or records, insurance claims, forensic analyses, news reports, telematic driving data, peer-reviewed research and/or any other driving data.

At step 304, the autonomous vehicle performance assessment system 104 (for example, the scenario module 206) receives scenario features. A scenario may refer to a situation which an autonomous vehicle may encounter, and which has been, may be, and/or will be encountered by a human driver or a population of human drivers. A scenario may include one or more road portions. In some embodiments, the scenario may also include and one or more hazards. A road portion may be any part of a road, track, or any other surface upon which a vehicle may travel. Scenario features, which may be attributes or characteristics of scenarios, such as the one or more road portions and/or the one or more hazards, may include any or all of the following: road geometry and/or road features (for example, presence of an intersection, number of lanes in the road, lane line types, whether lanes are two-way or one-way, presence of dedicated turn lanes, presence of crosswalks, etc.); characterizations of the environment (for example, parking lot, highway, residential road, school zone, etc.); and aspects of the environment (for example, speed limit, traffic conditions, weather conditions, lighting conditions, road conditions (for example, pothole, obstruction, etc.), etc.). Scenario features may also include any or all of the following: the presence and/or behavior of other vehicles and/or pedestrians and/or objects in the environment (for example, number and location of other environmental vehicles, speed at which other vehicles are traveling, location of pedestrians relative to the vehicle, location and/or type of obstacles near the vehicle, intent of other vehicles, etc.); the absolute or relative movement/kinematic parameters of the other vehicles and/or pedestrians and/or objects; a time-to-collision between a vehicle and other vehicles and/or pedestrians and/or objects; and/or any other features. It will be understood that a scenario feature may include any aspect of a scenario.

In some embodiments, the scenario features that the autonomous vehicle performance assessment system 104 receives may be defined, specified, or set by an entity that operates the autonomous vehicle performance assessment system 104. In various embodiments, the scenario features may be defined, specified, or set by any entity that operates any of the systems described with reference to, for example, FIG. 1.

At step 306, the autonomous vehicle performance assessment system 104 (for example, the scenario module 206) extracts scenario features from the data associated with human driving performance to obtain extracted scenario features. The autonomous vehicle performance assessment system 104 may also extract human driving performance data from the data associated with human driving performance to obtain extracted human driving performance data. Human driving performance data may include any data related to, associated with, and/or based on human drivers of vehicles, such as perception and reaction times in response to encountering hazards on roads, acceleration and/or deceleration rates, navigating turns, curves, and ascents or descents. The autonomous vehicle performance assessment system 104 may extract human driving performance data using any appropriate method or combination of methods, such as statistical analysis, human factors analysis of driver behavior, observations of driver behavior, forensic collision reconstruction, and actuarial analysis. The autonomous vehicle performance assessment system 104 may also receive human driving performance data from subject matter expert opinion and/or other means of scientific inquiry.

At step 308, the autonomous vehicle performance assessment system 104 (for example, the scenario module 206) transforms the extracted scenario features to obtain transformed scenario features. For example, the autonomous vehicle performance assessment system 104 may normalize the extracted scenario features to a particular schema, structure, and/or other requirements. Also at step 308 the autonomous vehicle performance assessment system 104 (for example, the scenario module 206) loads the transformed scenario features into the scenario datastore 218. The autonomous vehicle performance assessment system 104 may also transform the extracted human driving performance data to obtain transformed human driving performance data. For example, the autonomous vehicle performance assessment system 104 may normalize the extracted human driving performance data to a particular schema, structure, and/or other requirements. Also at step 308 the autonomous vehicle performance assessment system 104 (for example, the performance module 210) loads the transformed human driving performance data into the performance datastore 222.

The autonomous vehicle performance assessment system 104 may allow scenarios to be tagged with descriptors and/or categorized. Such descriptors and/or category information may be usable for identification or selection of scenarios. For example, a scenario may be tagged with information indicating a specific regulatory agency. As another example, a scenario may be tagged with information identifying a particular autonomous vehicle operator. As yet another example, a scenario may be tagged with information identifying a particular test or suite of tests that an autonomous vehicle must successfully pass in order to meet a law or regulation.

At step 310, the autonomous vehicle performance assessment system 104 (for example, the tag module 216) receives tags to associate with scenarios. As noted herein, a tag may include information usable for selection of a scenario with which it is associated. At step 312, the autonomous vehicle performance assessment system 104 (for example, the tag module 216) stores the tags in association with the appropriate scenarios. At step 314, the autonomous vehicle performance assessment system 104 (for example, the scenario module 206) receives an objective. The objective may indicate a purpose for assessing the performance of autonomous vehicles. For example, the objective may include compliance with one or more laws or regulations in force or that will be in force in the future, and the purpose may include demonstration of compliance with the one or more laws or regulations. As another example, the objective may include passing one or more tests of an autonomous vehicle operator, and the purpose may include successfully passing the one or more tests of the autonomous vehicle operator. As another example, the objective may include meeting one or more requirements, performance targets, or the like of the entity operating the autonomous vehicle performance assessment system 104, a subunit thereof, and/or an autonomous vehicle operator, and the purpose may include successfully meeting the one or more requirements, performance targets, or the like of the entity operating the autonomous vehicle performance assessment system 104, the subunit thereof, and/or the autonomous vehicle operator.

At step 316 the autonomous vehicle performance assessment system 104 (for example, the scenario module 206) identifies one or more scenarios based on the objective and the tags stored in association with the scenarios in the scenario datastore 218. For example, the autonomous vehicle performance assessment system 104 may identify or select a subset of the scenarios in the scenario datastore 218 based on an objective that includes meeting the laws or regulations of a specific United States state for the purpose of demonstrating compliance with the laws or regulations.

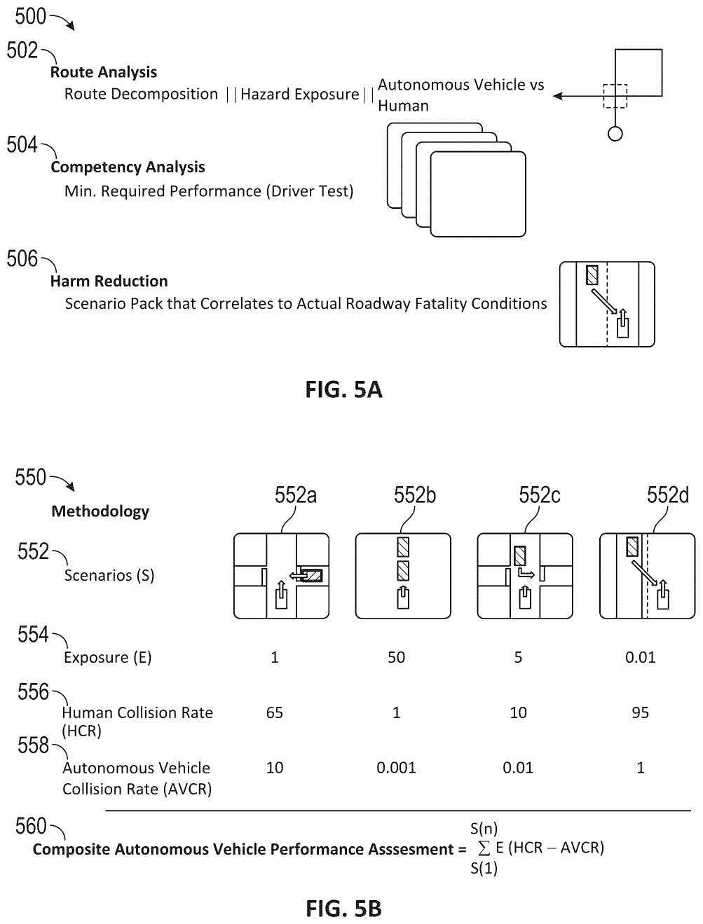

The autonomous vehicle performance assessment system 104 may identify or select scenarios using other methods additionally or alternatively to the method 300. FIG. 5A is a block diagram depicting a methodology 500 for identifying scenarios for assessing the performance of autonomous vehicles in some embodiments. The methodology 550 may include a step 502 of analyzing one or more routes that autonomous vehicles may take. Such route analysis may involve decomposing the route into one or more scenarios, determining a hazard exposure for the one or more scenarios, and assessing autonomous vehicle performance in view of human driver performance for the one or more scenarios. The methodology 550 may also include a step 504 of analyzing competency of autonomous vehicles for the one or more scenarios in view of a minimum level of performance that may be required by regulatory agencies. The methodology 550 may also include a step 506 of harm reduction that involves assessing autonomous vehicle performance in scenarios that correlate to actual roadway fatality conditions.

In various embodiments, the scenarios may be identified or selected in accordance with a set of fixed routes that autonomous vehicles of an autonomous vehicle operator are configured to traverse, such as in the use case of deliveries (for example, middle mile deliveries). For example, autonomous vehicles may be configured to travel along only a predefined set of fixed routes between distribution centers, warehouses, retailers, home bases, and/or any other predetermined locations. The scenarios may be selected so as to include any or all of the scenarios which the autonomous vehicles may encounter along the fixed route network. Additionally or alternatively, the set of scenarios may be those outside of the set of fixed routes. It will be understood that other objectives and purposes are possible.

In some embodiments, the autonomous vehicle performance assessment system 104 may generate synthetic human driving performance data for scenarios. For example, the autonomous vehicle performance assessment system 104 may not have sufficient human driving performance data for one or more scenarios which autonomous vehicles are to experience. The autonomous vehicle performance assessment system 104 may generate synthetic human driving performance data based on actual human driving performance data in other scenarios so as to ensure that there is enough human driving performance data so as to be able to make statistically significant conclusions regarding autonomous vehicle performance.

FIG. 3B is a flow diagram depicting a method 350 for assessing the performance of autonomous vehicles in some embodiments. Various modules of the autonomous vehicle performance assessment system 104 may perform the method 350. In some embodiments, some or all of the method 350 may be performed by the simulation system 102, the regulatory agency system 106, the autonomous vehicle operator system 110, and/or other systems.

The method 350 begins at step 352, where the autonomous vehicle performance assessment system 104 (for example, the scenario module 206) receives multiple scenarios from the scenario datastore 218. For example, the autonomous vehicle performance assessment system 104 may identify multiple scenarios that may be used to demonstrate compliance with a suite of tests required by a regulatory agency and receive those scenarios from the scenario datastore 218. The multiple scenarios that the autonomous vehicle performance assessment system 104 receives may be selected, identified, and/or determined by any of the methods described herein

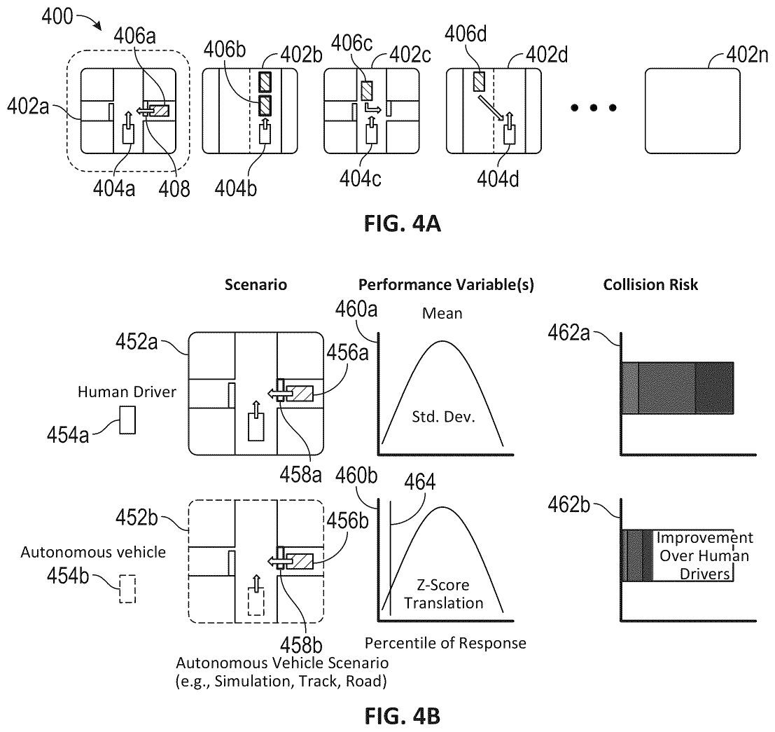

FIG. 4A is a block diagram depicting a set of multiple scenarios for human drivers and for autonomous vehicles in some embodiments. Each of the multiple scenarios includes a human driver driving a vehicle along one or more portions of one or more roads and encountering one or more hazards or non-emergency situations (example e.g., a stop sign). The set 400 includes a scenario 402a, which includes a first vehicle 404a being driven by a human driver on a first road portion and a second vehicle 406a (which may also be driven by a human driver) on a second road portion. The first vehicle 404a is traveling on the road portion with right-of-way in a direction perpendicular to a direction of travel of the second vehicle 406a, which has a stop sign 408. The scenario 402a depicts that the second vehicle 406a is not stopping at the stop sign 408 despite the first vehicle 404a having the right-of-way. Accordingly, the second vehicle 406a may present a hazard to the first vehicle 404a. In a real-world scenario corresponding to the scenario 402a, the human driver of the first vehicle 404a may have to perform emergency braking and/or other maneuvers to avoid a collision with the second vehicle 406a.

The set 400 also includes a scenario 402b. The scenario 402b includes a first vehicle 404b being driven by a human driver and a second vehicle 406b (which may also be driven by a human driver) on a first road portion. The scenario 402b may represent stop-and-go traffic and/or the second vehicle 406b abruptly stopping in front of the first vehicle 404b. Accordingly, the second vehicle 406b may present a hazard to the first vehicle 404b. Similar to the human driver in the scenario 402a, the human driver of the first vehicle 404b may have to perform emergency braking and/or other maneuvers to avoid a collision with the second vehicle 406b.

The set 400 also includes a scenario 402c. The scenario 402c includes a first vehicle 404c being driven by a human driver and a second vehicle 406c (which may also be driven by a human driver) on a first road portion. The scenario 402c may represent the second vehicle 406c making a left turn in front of the first vehicle 404c without sufficient time to make the left turn. Accordingly, the second vehicle 406c may present a hazard to the first vehicle 404c. Similar to the human drivers in the scenario 402a and/or the scenario 402b, the human driver of the first vehicle 404c may have to perform emergency braking and/or other maneuvers to avoid a collision with the second vehicle 406c.

The set 400 also includes a scenario 402d. The scenario 402d includes a first vehicle 404d being driven by a human driver and a second vehicle 406d (which may also be driven by a human driver) on a first road portion. The scenario 402d may represent the second vehicle 406d crossing the centerline into the lane of the first road portion on which the first vehicle 404d is traveling. Accordingly, the second vehicle 406d may present a hazard to the first vehicle 404d. Similar to the human drivers in the scenario 402a, the scenario 402b, and/or the scenario 402c, the human driver of the first vehicle 404d may have to perform emergency braking and/or other maneuvers to avoid a collision with the second vehicle 406d. The set 400 may include any number of other scenarios as indicated by scenario 402n.

Although each of the multiple scenarios depicted in FIG. 4A includes a human driver driving a vehicle along one or more portions of one or more roads and encountering one or more hazards, it is to be understood that scenarios do not necessarily have to include one or more hazards. For example, a scenario may include a road portion that has a stop sign or a red light, and the associated human driving performance data may include data on how human drivers come to a stop at the stop sign or the red light. For example, the multiple scenarios may include hazards, non-hazards, emergency situations, non-emergency situations, and the like.

Returning to FIG. 3B, at step 354 the autonomous vehicle performance assessment system 104 (for example, the scenario module 206) provides the multiple scenarios for simulation and/or road and/or track testing. For example, the autonomous vehicle performance assessment system 104 may provide the multiple scenarios to the simulation system 102 for simulation of autonomous vehicle performance in multiple simulated scenarios corresponding to the multiple scenarios. In some embodiments, simulation of autonomous vehicle performance may include simulating performance of the autonomous vehicle system in a simulated or virtual environment, such as a computer simulation. The autonomous vehicle performance assessment system 104 may also provide autonomous vehicle data, such as data regarding autonomous vehicle characteristics, to the simulation system 102 for use in the simulations. In various embodiments, in addition to or as an alternative to providing the multiple scenarios to the simulation system 102, the autonomous vehicle performance assessment system 104 (for example, the simulation module 208) may perform simulations of autonomous vehicles in multiple simulated scenarios corresponding to the multiple scenarios.

As another example, the autonomous vehicle performance assessment system 104 may provide the multiple scenarios for use in road and/or track testing. An autonomous vehicles may be put into a reconstructed scenario on a road and/or a track that include one or more road portions that are at least generally similar to the one or more road portions of the scenario and encounter one or more hazards that are at least generally similar to the one or more scenario hazards. For example, a scenario may be recreated on a closed road course with one or more hazards that are at least generally similar to the scenario hazards.

In some embodiments, for each scenario, the simulation system 102 may perform one or more simulations of one or more autonomous vehicles driving on one or more simulated road portions that are at least generally similar to the one or more scenario road portions and encountering one or more simulated hazards that are at least generally similar to the one or more scenario hazards.

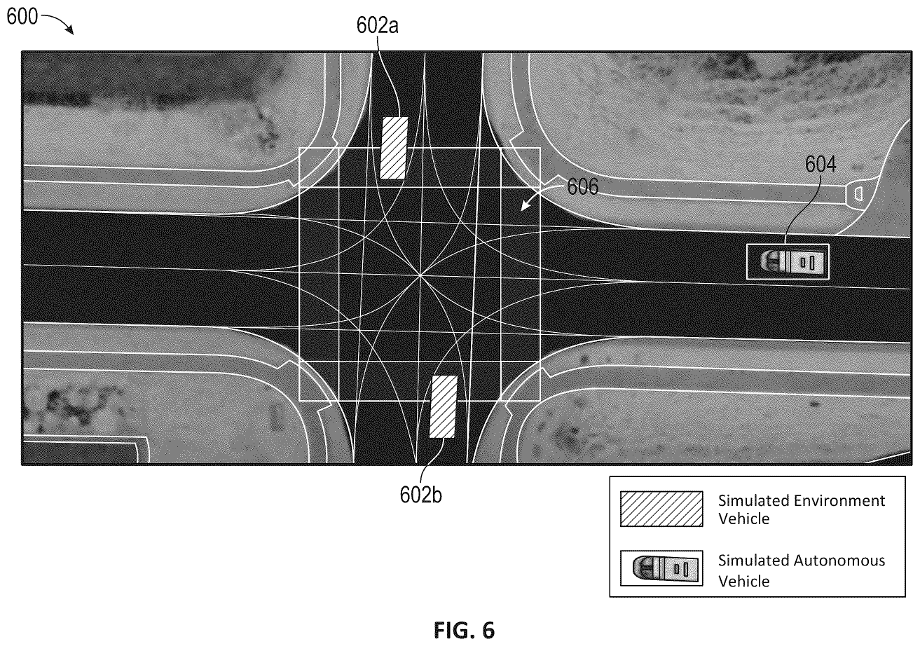

FIG. 6 depicts a simulation environment 600 in which a simulated autonomous vehicle 604 is driving on one or more simulated road portions 606 and encountering one or more simulated hazards of a simulated scenario in some embodiments. The one or more simulated hazards may include one or both of the simulated environmental vehicle 602a and the simulated environmental vehicle 602b. Although both the simulated environmental vehicle 602a and the simulated environmental vehicle 602b are stopped at the intersection of the two road portions and the simulated autonomous vehicle 604 has the right of way, one or both of the simulated environmental vehicle 602a and the simulated environmental vehicle 602b may move into the intersection, thus presenting a hazard to the simulated autonomous vehicle 604.

Returning to FIG. 3B, at step 356, the autonomous vehicle performance assessment system 104 (for example the performance module 210) receives one or more human driver performance metrics. In FIG. 4B in the scenario 452a, the vehicle 454a operated by a human driver is traveling along a road portion in the direction indicated and the vehicle 456a is initially stopped on a perpendicular road portion at the stop sign 458a. The vehicle 456a unexpectedly enters the intersection creating an emergency collision hazard. A significant factor in how likely a collision results from a hazardous situation is based on how timely the reaction of the human driver is to the hazard.

The autonomous vehicle performance assessment system 104 may base the one or more human driver performance metrics on the driving performances of one or more human drivers on one or more road portions that are at least generally similar to the one or more scenario road portions when the one or more human drivers encountered one or more hazards that are at least generally similar to the one or more scenario hazards. One example human driver performance metric may be or include perception and reaction times. A perception and reaction time may be the amount of time between when a hazard is manifested to a human driver and when the human driver starts emergency brake application. Human drivers in this situation have been shown to respond to this type of hazard on average with a particular average perception and reaction time, which is the time between hazard presentation onset (for example, the start of the movement of the vehicle 456a into the intersection) and emergency brake application (for example, the application of the brake by the human driver of the vehicle 454a). In addition, there may be a statistical distribution of reaction times across many human drivers that have confronted the one or more scenario hazards that are at least generally similar to the one or more scenario hazards. The autonomous vehicle performance assessment system 104 may generate the one or more human driver performance metrics from the human driving performance data stored in the performance datastore 222. Additionally or alternatively, the one or more human driver performance metrics may be stored in the performance datastore 222 and the autonomous vehicle performance assessment system 104 may receive the one or more human driver performance metrics from the performance datastore 222.

Returning to FIG. 3B, at step 358, for each of the multiple scenarios, the autonomous vehicle performance assessment system 104 (for example the simulation module 208) receives autonomous vehicle performance data from the simulation and/or road and/or track testing. For example, the autonomous vehicle performance assessment system 104 may receive autonomous vehicle performance data that includes simulation results data for one or more simulated autonomous vehicles driving on one or more simulated road portions and encountering one or more simulated hazards. As another example, the autonomous vehicle performance assessment system 104 may receive autonomous vehicle performance data that includes road and/or track testing results data for one or more autonomous vehicles driving on one or more road portions and encountering one or more hazards.

At step 360, for each of the multiple scenarios, the autonomous vehicle performance assessment system 104 (for example the performance module 210) determines one or more autonomous vehicle performance metrics based on the autonomous vehicle performance data. For example, the autonomous vehicle performance assessment system 104 may obtain simulated perception and reaction times for autonomous vehicles from the simulated results data. As another example, the autonomous vehicle performance assessment system 104 may obtain actual perception and reaction times for braking and/or performing collision avoidance maneuvers from the road and/or track testing results data. In FIG. 4B, scenario 452b is at least generally similar to scenario 452a. The scenario 452b, which may be a simulated scenario or a recreated or reconstituted scenario on a road and/or a track, includes one or more road portions at least generally similar to the one or more road portions included in scenario 452a and one or more hazards at least generally similar to the one or more hazards included in scenario 452a. In the scenario 452b, autonomous vehicle 454b is traveling along a road portion in the direction indicated and the vehicle 456b is initially stopped on a perpendicular road portion at the stop sign 458b. The vehicle 456b unexpectedly enters the intersection creating an emergency collision hazard. A significant factor in how likely a collision results from a hazardous situation is based on how timely the reaction of the autonomous vehicle is to the hazard.

Although the scenario 452b depicted in FIG. 4B includes the autonomous vehicle 454b encountering a hazard in the form of the vehicle 456b unexpectedly entering the intersection creating an emergency collision hazard, it is to be understood that recreated, reconstituted, or simulated scenarios for autonomous vehicles do not necessarily have to include one or more hazards. For example, a recreated, reconstituted, or simulated scenario for an autonomous vehicle may include a road portion that has a stop sign or a red light, and the associated autonomous vehicle performance data may include data on how autonomous vehicles come to a stop at the stop sign or the red light.

At step 362, the autonomous vehicle performance assessment system 104 (for example, the performance assessment module 212) generates one or more scenario autonomous vehicle performance assessments based on the one or more human driver performance metrics and the one or more autonomous vehicle performance metrics. For example, the autonomous vehicle performance assessment system 104 may create a histogram of perception and reaction times of multiple human drivers in the scenario 452a, as displayed in graph 460a. The autonomous vehicle performance assessment system 104 may calculate the mean perception and reaction time and the standard deviation. In the scenario 452a, the mean perception and reaction time of human drivers may be approximately 1.5 seconds, with a 5th to 95th percentile (approximately two standard deviations from the mean) of approximately one to approximately two seconds. Human drivers responding to a threat within this timeframe may or may not avoid a collision when provided about 2.75 seconds to react prior to impact. In dry road conditions, the collision rate may be approximately 40% among 192 human drivers, whereas the collision rate may be approximately 72% in wet road conditions. The autonomous vehicle performance assessment system 104 may determine a collision risk for human drivers based on the human driver performance metrics in view of the scenario 452a, and the collision risk may be graphed, as displayed in graph 462a. The autonomous vehicle performance assessment system 104 may determine a collision risk for human drivers based on the mean perception and reaction time or on one or more standard deviations from the mean perception and reaction time. Additionally or alternatively, the autonomous vehicle performance assessment system 104 may have extracted collision risks, collision rates, and/or similar metrics from human driving performance data and stored the collision risks, the collision rates, and/or the similar metrics in the performance datastore 222. The autonomous vehicle performance assessment system 104 may receive the collision risks, the collision rates, and/or the similar metrics from the performance datastore 222. Further, the autonomous vehicle performance assessment system 104 may be generated based on any information, including, for example, the databases herein and/or based on scenario data, research papers, studies, and/or the like.

It will also be appreciated that the autonomous vehicle performance assessment system 104 may extract human driving performance data including how “human” the autonomous vehicle is driving (e.g., slowing to a stop at a traffic light, changing lanes, and/or the like).

The autonomous vehicle performance assessment system 104 may generate a z-score using the one or more autonomous vehicle performance metrics and the human driver performance metrics. For example, the autonomous vehicle performance assessment system 104 may use the perception and reaction time of the autonomous vehicle 454b in the scenario 452b and the mean human driver perception and reaction time and the standard deviation for human drivers in the scenario 452a to generate the z-score. The autonomous vehicle performance assessment system 104 may then calculate the percentile of the autonomous vehicle 454b, as indicated by a line 464 in the graph 460b. The autonomous vehicle performance assessment system 104 may then determine a collision risk for autonomous vehicles based on the autonomous vehicle performance metrics in view of the scenario 452b, and the collision risk may be graphed, as displayed in graph 462b. The graph 462b may also display the improvement over human drivers.

At step 364, the autonomous vehicle performance assessment system 104 (for example, the performance assessment module 212) generates one or more composite autonomous vehicle performance assessments based on the one or more scenario autonomous vehicle performance assessments generated for each scenario of the multiple scenarios. FIG. 5B is a block diagram depicting a methodology 550 for generating autonomous vehicle performance assessments in some embodiments. The methodology 550 includes, for each scenario (such as for each scenario 552 of the scenarios in FIG. 5B, shown individually as scenario 552a, scenario 552b, scenario 552c, and scenario 552d), determining an exposure metric 554 (which may reflect frequency and/or severity of harm) for the scenario 552, a human collision rate 556 for the scenario 552, and an autonomous vehicle collision rate 558 for the scenario 552. The autonomous vehicle performance assessment system 104 (for example, the performance assessment module 212) may determine an exposure metric for each scenario based on a likelihood or probability of an autonomous vehicle experiencing the scenario in a real-world situation. Any of the exposure metric 554, the human collision rate 556, and the autonomous vehicle collision rate 558 may be expressed as a percentage or as another value. The autonomous vehicle performance assessment system 104 may utilize scenario data (for example, collision history databases, insurance claims, traffic studies, etc.) to determine the exposure metric for the scenario.

The methodology 550 further includes, for each scenario 552, generating the composite autonomous vehicle performance assessment 560. The autonomous vehicle performance assessment system 104 may generate an autonomous vehicle performance assessment for a scenario 552 by determining a difference between the human collision rate 556 and the autonomous vehicle collision rate 558 and determining a product of the exposure metric and the difference to obtain the autonomous vehicle performance assessment for the scenario. The autonomous vehicle performance assessment system 104 may generate the composite autonomous vehicle performance assessment 560 by determining a sum of the autonomous vehicle performance assessments generated for each scenario to obtain the composite autonomous vehicle performance assessment 560. It will be understood that the autonomous vehicle performance assessment system 104 may generate the composite autonomous vehicle performance assessment 560 using other techniques and/or methodologies. Furthermore, the specific numerical values and/or percentages in FIG. 5B are for illustrative purpose and could include any variation of frequency, percentages, combination of metrics or unitless measures or scores.

At step 366, the autonomous vehicle performance assessment system 104 (for example, the reporting module 214) provides the one or more composite autonomous vehicle performance assessments. For example, the autonomous vehicle performance assessment system 104 may provide the one or more composite autonomous vehicle performance assessments to any of the regulatory agency system 106 and the autonomous vehicle operator system 110. In some embodiments, the autonomous vehicle performance assessment system 104 may provide reports in real-time to the regulatory agency system 106 and/or other systems to document compliance with regulatory requirements.

The method 350 may be performed using autonomous vehicle performance data from various windows of time. For example, the method 350 may be performed using autonomous vehicle performance data from a six-month historical period. As another example, the method 350 may be performed using autonomous vehicle performance data from a more current window, such as the previous hour, the previous 12 hours, the previous 24 hours, or the like, so as to generate and provide real-time or generally real-time assessments.

In some embodiments, the autonomous vehicle performance assessment system 104 may determine metrics associated with the harm caused by human drivers in scenarios and/or the metrics associated with the harm caused by autonomous vehicles in reconstituted, recreated, and/or simulated scenarios. For example, the autonomous vehicle performance assessment system 104 may determine personal injury and/or property damage caused by human drivers in scenarios. The autonomous vehicle performance assessment system 104 may calculate personal injury and/or property damage (in terms of dollar amounts or any other appropriate measuring unit) or may receive extracted personal injury and/or property damage from the performance datastore 222. As another example, the autonomous vehicle performance assessment system 104 may determine the harm caused by autonomous vehicles in reconstituted, recreated, and/or simulated scenarios by estimating, calculating, and/or otherwise determining personal injury and/or property damage (in terms of dollar amounts or any other appropriate measuring unit) based on the autonomous vehicle performance data. The autonomous vehicle performance assessment system 104 may determine the metrics associated with the harm caused by human drivers in scenarios and/or the metrics associated with the harm caused by autonomous vehicles in reconstituted, recreated, and/or simulated scenarios in addition to or as an alternative to the other human driver performance metrics and/or the autonomous vehicle performance metrics discussed herein. It will be understood that human driver performance metrics and/or autonomous vehicle performance metrics may be based on any appropriate quantifiable data.

In some embodiments, the autonomous vehicle performance assessment system 104 may generate the one or more scenario autonomous vehicle performance assessments based on the reduction(s) in the harm(s) caused by autonomous vehicles in relation to the harm(s) caused by human drivers. The autonomous vehicle performance assessment system 104 may generate the one or more composite autonomous vehicle performance assessments based on the total reduction(s) in the harm(s) caused by autonomous vehicles in relation to the harm(s) caused by human drivers for the multiple scenarios.

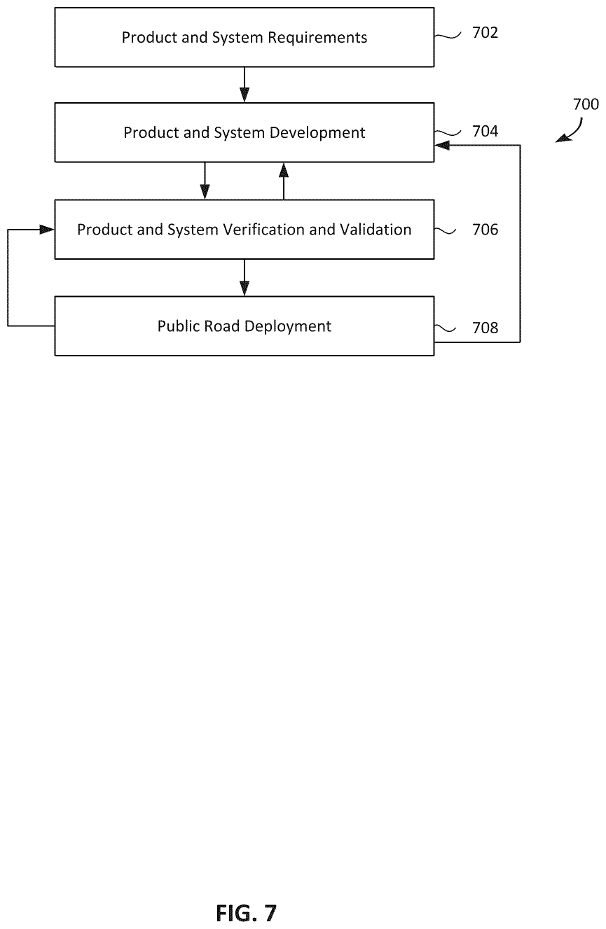

FIG. 7 is a flow diagram depicting a method 700 for autonomous vehicle development, verification, validation, and deployment in some embodiments. The method 700 begins at step 702 where product and system requirements are determined. At step 704 product and system development occurs. At step 706 product and system verification and validation is performed. Step 706 may proceed to either step 704 or step 708, where deployment of autonomous vehicles on public roads may occur. Step 708 may proceed to either step 704 or step 706.

Additionally or alternatively, the method 700 may include actions such as adjustment and/or design and/or re-design of hardware and/or software subsystems associated with autonomous vehicles (for example, determining/defining hardware component requirements, determining/defining software capabilities, including adjusting autonomous vehicle logic and decision-making, increasing the perception and/or abilities/performance of an autonomous vehicle in response to determining that poor perception contributes to increased collision risk at certain scenarios, etc.), a selection and/or refinement of the fixed routes traveled by autonomous vehicles (for example, static or dynamic adjustment of a route to avoid a particular scenario which contributes to collision risk above a predetermined threshold), an adjustment in the trained models which are implemented in decision making by the autonomous vehicle and/or an adjustment in the execution of the trained models (for example, specifying/limiting which actions are available for selection by the autonomous vehicle in each context); a refinement of which minimal risk conditions can be triggered in each scenario, and/or any other actions that may improve upon the human benchmark of collision risk and on-road safety and/or allow for better comparison of autonomous vehicle performance against a human benchmark.

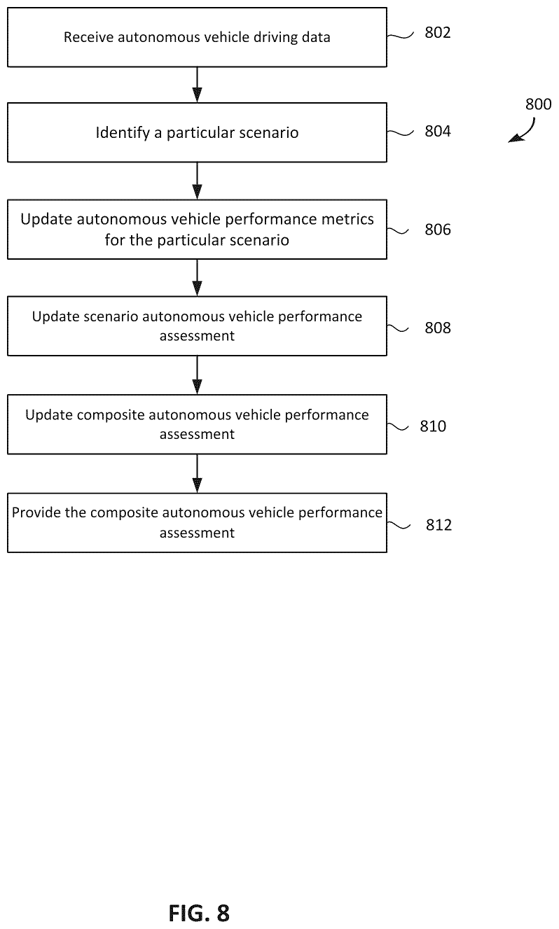

FIG. 8 is a flow diagram depicting a method 800 for updating performance assessments of autonomous vehicles in some embodiments. Various modules of the autonomous vehicle performance assessment system 104 may perform the method 800. In some embodiments, some or all of the method 350 may be performed by the simulation system 102, the regulatory agency system 106, the autonomous vehicle operator system 110, and/or other systems.

The method 800 begins at step 802, where the autonomous vehicle performance assessment system 104 (for example, the communication module 202) receives autonomous vehicle driving data for one or more autonomous vehicles driving on one or more road portions and encountering one or more hazards. At step 804, the autonomous vehicle performance assessment system 104 (for example, the scenario module 206) identifies a particular scenario of the scenarios in the scenario datastore 218 based on the one or more road portions and the one or more hazards. For example, the autonomous vehicle performance assessment system 104 may identify the particular scenario based on a degree of similarity of the one or more road portions to one or more road portions in the particular scenario and on a degree of similarity of the one or more hazards to one or more hazards in the particular scenario.

At step 806, the autonomous vehicle performance assessment system 104 (for example, the performance assessment module 212) updates one or more autonomous vehicle performance metrics for the particular scenario based on the autonomous vehicle driving data and thereby obtains one or more updated autonomous vehicle performance metrics. At step 808, the autonomous vehicle performance assessment system 104 (for example, the performance assessment module 212) updates one or more scenario autonomous vehicle performance assessments based on the one or more updated autonomous vehicle performance metrics and thereby obtains one or more updated scenario autonomous vehicle performance assessments.

At step 810, the autonomous vehicle performance assessment system 104 (for example, the performance assessment module 212) updates the one or more composite autonomous vehicle performance assessments based on the one or more updated scenario autonomous vehicle performance assessments and thereby obtains one or more updated composite autonomous vehicle performance assessments. At step 812, the autonomous vehicle performance assessment system 104 (for example, the reporting module 214) provides the one or more updated composite autonomous vehicle performance assessments. For example, the autonomous vehicle performance assessment system 104 may provide the one or more updated composite autonomous vehicle performance assessments to any of the regulatory agency system 106, the autonomous vehicle operator system 110, and/or other systems. The autonomous vehicle performance assessment system 104 may store a history of the performance assessments of the autonomous vehicles.

One advantage of the autonomous vehicle performance assessment system 104 is that the autonomous vehicle performance assessment system 104 enables the determination of measurable outcomes of specific autonomous vehicle functional capabilities that directly relate to on-road performance, collision risk mitigation, and collision avoidance metrics. Another advantage is that the autonomous vehicle performance assessment system 104 assesses performance of autonomous vehicles using methodologies, paradigms, and/or approaches that are well-understood to regulators and operators of autonomous vehicles and are directly comparable to similar metrics and risk benchmarks already established in human driver performance baselines. Accordingly, such parties may be more convinced of the safety of autonomous vehicles and thus more likely to, in the case of regulators, permit them to operate on public roads, and, in the case of autonomous vehicle operators, utilize autonomous vehicles in the business or industry. Another advantage of the autonomous vehicle performance assessment system 104 is that the autonomous vehicle performance assessment system 104 does not rely on miles-driven assessments such as those used in conventional approaches to quantify safe and/or effective autonomous driving in comparison to human-driven vehicle operation.

Another advantage of the autonomous vehicle performance assessment system 104 is that the autonomous vehicle performance assessment system 104 allows for identification of a set of scenarios for the assessment and determination of the performance of a one or more autonomous vehicles. In specific examples, for instance, the set of scenarios enables a majority of scenarios/conditions that an autonomous vehicle could potentially encounter to be directly analyzed and the autonomous vehicle performance relative to these scenarios and their likelihood of occurrence (for example, within the traversals of autonomous vehicles of one or more fixed route networks) to be quantified and assessed, allowing for focused collision risk estimations along a given route for a given autonomous vehicle system. Furthermore, this approach may confer broad value allowing for the collision risk of autonomous vehicles to be compared against human driver collision risk across an assembly of hazard scenarios, components of a route or compilation of relevant driving competencies.

A further advantage of the autonomous vehicle performance assessment system 104 is that the autonomous vehicle performance assessment system 104 enables the determination of autonomous vehicle performance (for example, safety) metrics that can be used to provide actionable insights and/or trigger actions related to hardware systems, software systems (for example, autonomous vehicle stack logic, teleoperator interfacing, etc.), and/or any combination of systems associated with the autonomous vehicles to achieve and exceed performance of the common and/or highly skilled human driver. In some examples, for instance, direct assessments of vehicle performance and safety through the calculation of scenario-specific metrics can be used to design, inform, and/or modify features associated with the autonomous vehicle and/or its subsystems with the goals of benchmarking autonomous vehicle capabilities against any particular human driver demographic or performance metric, and developing performance goals that relate to a human driver benchmark (for example, 10 times better than an average human driver in a given scenario).

Other advantages of the autonomous vehicle performance assessment system 104 and/or the systems and methods described herein will be apparent.

FIG. 9 depicts a block diagram of an example digital device 900 according to some embodiments. The digital device 900 is shown in the form of a general-purpose computing device. The digital device 900 includes at least one processor 902, RAM 904, communication interface 906, input/output device 908, storage 910, and a system bus 912 that couples various system components including storage 910 to the at least one processor 902. A system, such as a computing system, may be or include one or more of the digital device 900.

System bus 912 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 900 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 902 is configured to execute executable instructions (for example, programs). In some embodiments, the at least one processor 902 comprises circuitry or any processor capable of processing the executable instructions.

In some embodiments, RAM 904 stores programs and/or data. In various embodiments, working data is stored within RAM 904. The data within RAM 904 may be cleared or ultimately transferred to storage 910, such as prior to reset and/or powering down the digital device 900.

In some embodiments, the digital device 900 is coupled to a network, such as the communication network 108, via communication interface 906. Still yet, the simulation system 102, the autonomous vehicle performance assessment system 104, and the regulatory agency system 106 can communicate with one or more networks such as a local area network (LAN), a general wide area network (WAN), and/or a public network (for example, the Internet).

In some embodiments, input/output device 908 is any device that inputs data (for example, mouse, keyboard, stylus, sensors, etc.) or outputs data (for example, speaker, display, virtual reality headset).

In some embodiments, storage 910 can include computer system readable media in the form of non-volatile memory, such as read only memory (ROM), programmable read only memory (PROM), solid-state drives (SSD), flash memory, and/or cache memory. Storage 910 may further include other removable/non-removable, volatile/non-volatile computer system storage media. By way of example only, storage 910 can be provided for reading from and writing to a non-removable, non-volatile magnetic media. The storage 910 may include a non-transitory computer-readable medium, or multiple non-transitory computer-readable media, which stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 912 by one or more data media interfaces. As will be further depicted and described below, storage 910 may include at least one program product having a set (for example, at least one) of program modules that are configured to carry out the functions of embodiments of the invention. In some embodiments, RAM 904 is found within storage 910.

Programs/utilities, having a set (at least one) of program modules, such as the autonomous vehicle performance assessment system 104, may be stored in storage 910 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 900. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled”, “couplable”, “operably coupled”, “communicably coupled” and the like to other components. Such description or illustration should be understood as indicating that such components may cooperate or interact with each other, and may be in direct or indirect physical, electrical, or communicative contact with each other.

Components may be described or illustrated as “configured to”, “adapted to”, “operative to”, “configurable to”, “adaptable to”, “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services”, and “providing products and services.”

It may be apparent that various modifications may be made, and other embodiments may be used without departing from the broader scope of the discussion herein. For example, while the autonomous vehicle performance assessment system 104 may be described as generating performance assessments for autonomous vehicles, the autonomous vehicle performance assessment system 104 may also generate safety assessments for autonomous vehicles. As another example, while scenario features are described as being extracted from data associated with human driving performance, scenario features may be extracted from other data, such as mapping data.

Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving multiple scenarios, each scenario of the multiple scenarios including one or more scenario road portions and one or more scenario hazards;
for each scenario of the multiple scenarios:
receiving human driver performance metrics, the human driver performance metrics based on driving performance of one or more human drivers on one or more road portions at least generally similar to the one or more scenario road portions when the one or more human drivers encountered one or more hazards at least generally similar to the one or more scenario hazards;
receiving simulation results data for one or more simulated autonomous vehicles driving on one or more simulated road portions at least generally similar to the one or more scenario road portions and encountering one or more simulated hazards at least generally similar to the one or more scenario hazards;
determining one or more autonomous vehicle performance metrics based on the simulation results data; and
generating one or more scenario autonomous vehicle performance assessments based on the human driver performance metrics and the one or more autonomous vehicle performance metrics;
generating one or more composite autonomous vehicle performance assessments based on the one or more scenario autonomous vehicle performance assessments generated for each scenario of the multiple scenarios; and
providing the one or more composite autonomous vehicle performance assessments.

2. The non-transitory computer-readable medium of claim 1 wherein the multiple scenarios are multiple first scenarios, the one or more scenario road portions are one or more first scenario road portions, the one or more scenario hazards are one or more first scenario hazards, and wherein the method further comprises:
receiving multiple second scenarios, each second scenario of the multiple second scenarios including one or more second scenario road portions and one or more second scenario hazards;
receiving one or more tags, a tag including information usable for selection of a second scenario of the multiple second scenarios;
storing the one or more tags in association with one or more second scenarios of the multiple second scenarios;
receiving an objective, the objective indicating a purpose for the one or more composite autonomous vehicle performance assessments; and
identifying a subset of second scenarios of the multiple second scenarios based on the objective and the one or more tags associated with the one or more second scenarios to obtain the multiple first scenarios.

3. The non-transitory computer-readable medium of claim 2 wherein the objective includes compliance with one or more laws or regulations and the purpose includes a demonstration of compliance with the one or more laws or regulations.

4. The non-transitory computer-readable medium of claim 1 wherein the human driver performance metrics include human perception and reaction times and the one or more autonomous vehicle performance metrics include one or more autonomous vehicle perception and reaction times.

5. The non-transitory computer-readable medium of claim 1, the method further comprising for each scenario of the multiple scenarios:
determining human collision rates or collision risks based on the human driver performance metrics; and
determining one or more autonomous vehicle collision rates or collision risks based on the one or more autonomous vehicle performance metrics.

6. The non-transitory computer-readable medium of claim 5, the method further comprising for each scenario of the multiple scenarios:
determining an exposure metric for each scenario based on a likelihood of experiencing each scenario, and wherein generating the one or more scenario autonomous vehicle performance assessments based on the one or more autonomous vehicle performance metrics and the human driver performance metrics includes:
determining a difference between a human collision rate or collision risk and an autonomous vehicle collision rate or collision risk; and
determining a product of the exposure metric and the difference to obtain the one or more scenario autonomous vehicle performance assessments.

7. The non-transitory computer-readable medium of claim 6 wherein generating the one or more composite autonomous vehicle performance assessments based on the one or more scenario autonomous vehicle performance assessments generated for each scenario of the multiple scenarios includes determining a sum of the one or more scenario autonomous vehicle performance assessments generated for each scenario of the multiple scenarios to obtain the one or more composite autonomous vehicle performance assessments.

8. The non-transitory computer-readable medium of claim 1 wherein the one or more road portions are one or more first road portions, the one or more hazards are one or more first hazards, and wherein the method further comprises:
receiving autonomous vehicle driving data for one or more autonomous vehicles driving on one or more second road portions and encountering one or more second hazards;
identifying a particular scenario of the multiple scenarios based on the one or more second road portions and the one or more second hazards;
based on the autonomous vehicle driving data, updating the one or more autonomous vehicle performance metrics for the particular scenario to obtain one or more updated autonomous vehicle performance metrics;
updating the one or more scenario autonomous vehicle performance assessments based on the one or more updated autonomous vehicle performance metrics to obtain one or more updated scenario autonomous vehicle performance assessments;
updating the one or more composite autonomous vehicle performance assessments based on the one or more updated scenario autonomous vehicle performance assessments to obtain one or more updated composite autonomous vehicle performance assessments; and
providing the one or more updated composite autonomous vehicle performance assessments.

9. A method comprising:
receiving a scenario, the scenario including one or more scenario road portions;
receiving one or more human driver performance metrics, the one or more human driver performance metrics based on driving performance of one or more human drivers on one or more first road portions at least generally similar to the one or more scenario road portions;
receiving one or more autonomous vehicle performance metrics, the one or more autonomous vehicle performance metrics based on one or more autonomous vehicles driving on one or more second road portions at least generally similar to the one or more scenario road portions;
generating one or more scenario autonomous vehicle performance assessments based on the one or more human driver performance metrics and the one or more autonomous vehicle performance metrics; and
providing the one or more scenario autonomous vehicle performance assessments.

10. The method of claim 9 wherein the one or more autonomous vehicle performance metrics are based on a simulated autonomous vehicle driving on one or more simulated road portions at least generally similar to the one or more scenario road portions.

11. The method of claim 9 wherein the one or more autonomous vehicle performance metrics are based on an autonomous vehicle driving on one or more road portions at least generally similar to the one or more scenario road portions.

12. The method of claim 9 further comprising:
receiving results data for the one or more autonomous vehicles driving on the one or more second road portions at least generally similar to the one or more scenario road portions; and
determining the one or more autonomous vehicle performance metrics based on the results data.

13. The method of claim 9 wherein the scenario is a first scenario, the one or more scenario road portions are one or more first scenario road portions, the one or more human driver performance metrics are one or more first human driver performance metrics, the one or more human drivers are one or more first human drivers, the one or more autonomous vehicle performance metrics are one or more first autonomous vehicle performance metrics, the one or more autonomous vehicles are one or more first autonomous vehicles, the one or more scenario autonomous vehicle performance assessments are one or more first scenario autonomous vehicle performance assessments, and wherein the method further comprises:
receiving a second scenario, the second scenario including one or more second scenario road portions;
receiving one or more second human driver performance metrics, the one or more second human driver performance metrics based on driving performance of one or more second human drivers on one or more third road portions at least generally similar to the one or more second scenario road portions;
receiving one or more second autonomous vehicle performance metrics, the one or more second autonomous vehicle performance metrics based on one or more second autonomous vehicles driving on one or more fourth road portions at least generally similar to the one or more second scenario road portions;
generating one or more second scenario autonomous vehicle performance assessments based on the one or more second human driver performance metrics and the one or more second autonomous vehicle performance metrics;
generating one or more composite autonomous vehicle performance assessments based on the one or more first scenario autonomous vehicle performance assessments and the one or more second scenario autonomous vehicle performance assessments; and
providing the one or more composite autonomous vehicle performance assessments.

14. The method of claim 13 further comprising:
receiving an objective for providing the one or more composite autonomous vehicle performance assessments; and
selecting the first scenario and the second scenario based on the objective.

15. The method of claim 14 wherein the objective includes compliance with one or more laws or regulations.

16. The method of claim 9 wherein the one or more human driver performance metrics include human perception and reaction times and the one or more autonomous vehicle performance metrics include one or more autonomous vehicle perception and reaction times.

17. The method of claim 9, further comprising:
determining one or more human collision rates or collision risks based on the one or more human driver performance metrics; and
determining one or more autonomous vehicle collision rates or collision risks based on the one or more autonomous vehicle performance metrics.

18. The method of claim 17, further comprising determining an exposure metric for the scenario based on a likelihood of experiencing the scenario, and wherein generating the one or more scenario autonomous vehicle performance assessments based on the one or more human driver performance metrics and the one or more autonomous vehicle performance metrics includes:
determining a difference between the one or more human collision rates or collision risks and the one or more autonomous vehicle collision rates or collision risks; and
determining a product of the exposure metric and the difference to obtain the one or more scenario autonomous vehicle performance assessments.

19. A system comprising at least one processor and memory containing executable instructions, the executable instructions being executable by the at least one processor to:
receive multiple scenarios, a scenario including one or more scenario road portions;
receive at least one human driver performance metric for each of the multiple scenarios, the at least one human driver performance metric based on driving performance of one or more human drivers on one or more first road portions at least generally similar to the one or more scenario road portions;
receive at least one autonomous vehicle performance metric for each of the multiple scenarios, the at least one autonomous vehicle performance metric based on one or more autonomous vehicles driving on one or more second road portions at least generally similar to the one or more scenario road portions;
generate at least one composite autonomous vehicle performance assessment for the multiple scenarios based on the at least one human driver performance metric for each of the multiple scenarios and the at least one autonomous vehicle performance metric for each of the multiple scenarios; and
provide the at least one composite autonomous vehicle performance assessment for the multiple scenarios.

20. The system of claim 19, the executable instructions being further executable by the at least one processor to:
receive an objective for providing the at least one composite autonomous vehicle performance assessment for the multiple scenarios; and
select the multiple scenarios from a scenario datastore based on the objective.

21. The system of claim 20 wherein the objective includes compliance with one or more laws or regulations.

22. The system of claim 19 wherein the at least one human driver performance metric includes human perception and reaction times and the at least one autonomous vehicle performance metric includes at least one autonomous vehicle perception and reaction time.

23. The system of claim 19, wherein the scenario further includes one or more scenario hazards, the at least one human driver performance metric is further based on the driving performance of the one or more human drivers on the one or more first road portions when the one or more human drivers encountered one or more first hazards at least generally similar to the one or more scenario hazards, the at least one autonomous vehicle performance metric is further based on the one or more autonomous vehicles driving on the one or more second road portions and encountering one or more second hazards at least generally similar to the one or more scenario hazards, and wherein the executable instructions are further executable by the at least one processor to:
determine at least one human collision rate or collision risk based on the at least one human driver performance metric; and
determine at least one autonomous vehicle collision rate or collision risk based on the at least one autonomous vehicle performance metric.

24. The system of claim 23, the executable instructions being further executable by the at least one processor to:
determine an exposure metric for each of the multiple scenarios based on a likelihood of experiencing each scenario;
determine a difference between the at least one human collision rate or collision risk and the at least one autonomous vehicle collision rate or collision risk for each of the multiple scenarios; and
determine a product of the exposure metric and the difference to obtain at least one scenario autonomous vehicle performance assessment for each of the multiple scenarios.

25. The system of claim 24 wherein the executable instructions to generate the at least one composite autonomous vehicle performance assessment for the multiple scenarios based on the at least one human driver performance metric for each of the multiple scenarios and the at least one autonomous vehicle performance metric for each of the multiple scenarios include executable instructions to determine a sum of the at least one scenario autonomous vehicle performance assessment for each of the multiple scenarios to obtain the at least one composite autonomous vehicle performance assessment for the multiple scenarios.
